(19) United States
(12) Patent Application Publication
(10) Pub. No.: US 2017/0114244 A1
(43) Pub. Date: Apr. 27, 2017

(54) PEELABLE COMPOSITION

(71) Applicant: Lubrizol Advanced Materials, Inc., Cleveland, OH (US)

(72) Inventors: Hamidreza Hakimelahi, North Royalton, OH (US); Maria Nuria Paredes Garcia, Rubi (ES); Vic Stanislawczyk, Strongsville, OH (US); David J. Smith, Cleveland, OH (US)

(21) Appl. No.: 15/318,819

(22) PCT Filed: May 6, 2015
(86) PCT No.: PCT/US2015/029354

§ 371 Date: Dec. 14, 2016

Related U.S. Application Data
(60) Provisional application No. 62/013,721, filed on Jun. 18, 2014.

(51) Int. Cl. C09D 133/20; C09D 5/08; C09D 7/12; C08K 5/098; C09D 5/20

(52) U.S. Cl. CPC C09D 133/20; C08K 5/098; C09D 5/20; C09D 7/1233; C09D 5/08

(57) ABSTRACT

The disclosed technology provides a product obtained/obtainable by a process including (i) An emulsion polymer formed from any combination of ethylenically unsaturated monomers, to form an acrylic copolymer, wherein the acrylic copolymer has 0 to 4 wt % ethylenically unsaturated acid (or salts thereof) monomer based on the dry weight of the copolymer acid groups form acidic monomers, a linear Tg of up to 30° C., and an average particle size of 30 to 1000 nm, (ii) Contacting the copolymer of (i) with 0.1 to 20 wt % of a C₄₋₃₀ fatty acid or salt thereof (peelability enhancing agent) based upon the solid content of the product of step (i). The acrylic copolymer composition may be useful as a peelable coating composition.

### TECHNICAL FIELD

This disclosed technology relates to an emulsion polymer formed from any combination of ethylenically unsaturated monomers, to form an acrylic copolymer composition. The acrylic copolymer composition may be useful as a peelable coating composition.

### BACKGROUND OF THE INVENTION

Coatings are known for providing temporary protection and/or decoration finishes for motor vehicles and components thereof. In particular, the surface paint finishes of new vehicles are subject to various types of damage during various stages of construction, storage and after sale. Sources of damage may include acid rain, bird droppings, dust particles, other abrasive particles, and scratches. In addition to new vehicles, other products are also subjected to abrasive and deleterious conditions during transit, as well as during fabrication and assembly into other products. For instance, storm windows and other glass products must be specially protected to avoid scratching and marring during road and rail transit. Many products are protected during fabrication or assembly by downstream manufacturers. For example, plastic laminates and other materials with high-gloss finishes such as bathroom fixtures and chrome plated or brass surfaces must be protected not only during shipping, but also during installation or assembly into other products. The coatings used have been reported in a number of references described below and they typically provide composition that may be effective for protecting exposed surfaces of various products and components and can be removed by peeling.

U.S. Pat. No. 4,748,049 published on May 31, 1988 discloses a crystal clear paint spray booth barrier coatings compromising an aqueous solution of polyvinyl alcohol, a foam depressor for facilitating spray application and a wetting agent for facilitating application by a roller and providing a smooth, substantially transparent coating. This coating may be removed by either peeling or water washing.

U.S. Pat. No. 6,124,044 published on Sep. 26, 2000 discloses methods for protecting exterior surfaces of automobiles and other products, or components of products, against abrasion, abrasive dust, water, acid rain, etc. A protective coating comprises an emulsion selected from the group consisting of a vinyl-acrylic copolymer emulsion and a vinyl acetate-ethylene emulsion is disclosed. The emulsion is dried to form water-resistant protective coating that can be removed from underlying surface by peeling when no longer desired.

U.S. Pat. No. 6,211,282 B1 published on Apr. 3, 2001 discloses an aqueous dispersion of a peelable coating with following characteristics 1) a mixture containing 5-40% by weight of an emulsion of an acrylic copolymer having a glass transition temperature (T_{g}) of not lower than 40° C., and 9-60% by weight of an emulsion of another acrylic copolymer having a T_{g} ranging from −20° C. through 5° C. the acrylic copolymer emulsion, 2) the acrylic copolymer emulsion contains ethylenically unsaturated vinyl monomers having acid value in a total amount of 0.5-1.0% by weight, 3) at least one of the acrylic copolymer emulsions is an acrylic copolymer which has been polymerized by use of a reactive surfactant, and 4) the particle size of the acrylic copolymer emulsion is not more than 200 nm.

U.S. Pat. No. 6,620,890 B1 published on Sep. 6, 2003 discloses a composition for peelable coating, which exhibits excellent properties such as film-formability and water resistance and can be dried at ambient temperature without any particular heating. The composition contains a core/shell copolymer including an acrylic copolymer portion A having a high glass transition temperature of 30° C. to 70° C. and an acrylic copolymer portion B having a low glass transition temperature and being formed through multi-step polymerization.

U.S. Pat. No. 6,822,012 B1 published on Nov. 23, 2004 discloses an invention relating generally to water resistant peelable protective and decorative clear or pigmented coating compositions and, more specifically, to aqueous and solvent based, polymeric coating compositions which form a protective and/or decorative coating that removably adheres to a variety of substrates, including automotive paints, metals, glass, vinyl, plastics, concrete, natural and synthetic elastomers, and ceramics. The coating may be formulated for temporary or long-term protection.

U.S. Pat. No. 7,323,239 B2 published on Jan. 29, 2008 discloses multilayer protective films that adhere well to many different surfaces and can be removed without leaving residues. These films consist of a polyolefin backing layer(s) and an adhering layer consisting of an ethylene unsaturated ester copolymer layer containing resin. The films have good tensile strength and stiffness at minimum thickness and can be produced by blown film and cast processes, and mono and co-extrusion.

US 2010/0183901 A1 published on Jul. 22, 2010 discloses an invention relating to an aqueous coating composition for forming a peelable temporary coating on a substrate. The aqueous coating composition comprises at least one water based film-forming polymer and solid particles of an amino resin based polymer.

### SUMMARY OF THE INVENTION

The disclosed technology, may solve at least one problem of providing a peelable composition, providing a peelable composition having corrosion resistance, a peelable composition having water resistance, or a peelable composition having corrosion and water resistance.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

The disclosed technology provides an emulsion acrylic copolymer wherein the acrylic copolymer has 0 to 4 wt % ethylenically unsaturated acid (or salts thereof) monomer based on the dry weight of the copolymer acid groups form acidic monomers, 0 to 4 wt % of (meth)acrylamide monomer based on the dry weight of the copolymer, a linear Tg of up to 30° C., and an average particle size of 30 to 1000 nm.

The disclosed technology may provide an emulsion acrylic copolymer wherein the acrylic copolymer has 0 to 4 wt % ethylenically unsaturated acid (or salts thereof) monomer based on the dry weight of the copolymer acid groups form acidic monomers, 0 to 4 wt % of (meth)acrylamide monomer based on the dry weight of the copolymer, 0 to 6 wt % (or 0 to 4 wt %, or 1 to 3.5 wt %) of a crosslinker monomer, a linear Tg of up to 30° C., and an average particle size of 30 to 1000 nm.

The disclosed technology may provide an emulsion acrylic copolymer having gradient architecture, wherein the acrylic copolymer has 0 to 4 wt % ethylenically unsaturated acid (or salts thereof) monomer based on the dry weight of the copolymer acid groups form acidic monomers, 0 to 4 wt % of (meth)acrylamide monomer based on the dry weight of the copolymer, a linear Tg of up to 30° C., and an average particle size of 30 to 1000 nm. The emulsion acrylic copolymer may contain 0 to 6 wt % (or 0 to 4 wt %, or 1 to 3.5 wt %) of a crosslinker monomer.

The acrylic copolymer may be latex (an aqueous dispersion of acrylic resin).

In one embodiment the disclosed technology provides a product obtained/obtainable by a process comprising:

(i) forming an emulsion polymer from any combination of ethylenically unsaturated monomers, to form an acrylic copolymer, wherein the acrylic copolymer has 0 to 4 wt % ethylenically unsaturated acid (or salts thereof) monomer based on the dry weight of the copolymer acid groups form acidic monomers,

0 to 4 wt % of (meth)acrylamide monomer based on the dry weight of the copolymer, a linear Tg of up to 30° C., and
an average particle size of 30 to 1000 nm, or 50 to 900 nm, or 75 to 900 nm, or 80 to 700 nm, or 120 to 700 nm,

(ii) Contacting the copolymer of (i) with 0.1 to 20 wt % of a C₄₋₃₀ fatty acid or salt thereof (peelability enhancing agent) based upon the solid content of the product of step (i).

The product of step (i) may also be formed in the presence of 0 to 6 wt % (or 0 to 4 wt %, or 1 to 3.5 wt %) of a crosslinker monomer.

The process in one embodiment further comprises 0 wt % to 2 wt %, or 0.01 to 2 wt % of surfactant (such as an aliphatic or aromatic surfactant), typically an aromatic surfactant. The surfactant may be added at (i), or (ii), or both (i) and (ii).

The process in one embodiment further comprises contacting the product of (i) or (ii), or both (i) and (ii) with a wetting agent.

In one embodiment the process further comprises contacting the product of (i) or (ii), or both (i) and (ii) with 0.1 to 20 wt % of a wetting agent based upon the solid content of the product of step (i).

The disclosed technology may include a removable composition comprising 0.01 to 50 wt % of alkali removable agent, and 50 to 99.99 wt % of the product defined above.

The composition may be peelable, or removable by alkali.

The disclosed technology may include a coating composition comprising the acrylic copolymer disclosed herein.

The disclosed technology may include a method of protecting a surface comprising supplying to the surface a coating composition comprising the acrylic copolymer disclosed herein. The coating composition may form a film, typically a temporary layer/coating/film on the surface.

The surface may be a non-porous substrate. Examples of suitable non-porous substrates include metal which may have been pre-treated or not, pre-treated wood, synthetic polymeric materials, and glass. Further suitable substrates are other coats of paint, such as are present on transportation vehicles and motor vehicles or parts thereof.

The surface may be a metal surface that is painted or unpainted.

The surface may be chosen from hot rolled steel, cold rolled steel, carbon steel, copper, zinc, chromium, chromate, aluminium, galvanised steel, iron, or brass.

The surface may be flat, or ridged, undulated, laser cut, or otherwise shaped.

The disclosed technology may include a method of protecting a surface comprising forming a film on the surface of the acrylic copolymer described herein. The film may have a dry film thickness of 25 to 500 microns, or 75 to 100 microns, or 75 to 100 microns.

The disclosed technology also provides for the use of the copolymer disclosed herein on a metal surface to provide at least one of a peelable composition, providing a peelable composition having corrosion resistance, a peelable composition having water resistance, a peelable composition having corrosion and water resistance.

### DETAILED DESCRIPTION OF THE INVENTION

The disclosed technology provides a peelable copolymer, and a use as disclosed herein.

The glass transition temperature (“Tg”) of the emulsion copolymer should be maintained below about 90° C. Tg's used herein are those calculated by using Gordon and Taylor equation, see M. Gordon and J. S. Taylor: J. Appl. Chem., 2:493 (1952). In other words, for calculating the Tg of a copolymer of monomers M1 and M2,

$$Tg ( calc . ) = \frac{w ( M 1 ) \times Tg ( M 1 ) + k \times w ( M 2 ) \times Tg ( M 2 )}{w ( M 1 ) + k \times w ( M 2 )}$$

wherein Tg(calc.) is the glass transition temperature calculated for the copolymer, w(M1) is the weight fraction of monomer M1 in the copolymer, w(M2) is the weight fraction of monomer M2 in the copolymer, Tg(M1) is the glass transition temperature of the homopolymer of M1, and Tg(M2) is the glass transition temperature of the homopolymer of M2, k is a fitted constant, with all temperatures expressed in K. When k=1, a linear relationship results:

Tg(calc.)=w(M1)×Tg(M1)+w(M2)×Tg(M2)

Glass transition temperatures of homopolymers may be found, for example, in J. Brandrup and E. H. Immergut, ed., Polymer Handbook, Interscience Publishers.

The term “wt %” means the number of parts by weight of ingredient per 100 parts by weight of the composition or material of which the ingredient forms a part.

The term “aqueous medium” refers to a composition containing a substantial amount of water. The aqueous medium may contain other ingredients as well.

The terms “film” or “coating” refer to three dimensional shapes that may be useful as protective and/or decorative barriers or layers. The film or coating may be characterized as having one relatively small dimension, e.g. thickness, and two relatively large dimensions, e.g., length and width, especially when formed using a coating process such as brushing, rolling, spraying, and the like. The terms film and coating may also refer to other thicker protective and/or decorative barriers or layers such as caulks, sealants, and the like.

The expression “( )” such as “(meth)”, “(alk)”, or “(alkyl),” is used to indicate that the particular substituent in a chemical name is optionally present but may be absent. For example, the term “(meth)acrylate” may be used to refer to either acrylate or methacrylate.

The term “copolymer” is used herein to refer to a polymer derived from two or more different monomers. The term copolymer may be used to refer to terpolymers.

The copolymer may have a linear Tg of −30 to 30° C., or -5 to 20° C., or 0 to 15° C.

In one embodiment the acrylic copolymer may have a Tg of 0 to 7.5° C., and a particle size of 120 to 700 nm, or 120 to 200 nm.

In one embodiment when the emulsion acrylic copolymer contains a crosslinker monomer the copolymer may have a Tg of −30 to 30° C., or -5 to 20° C., or 0 to 18° C. The particle size of the acrylic copolymer containing crosslinker monomer may be 80 to 700 nm, or 120 to 700 nm, or 80 to 200 nm, or 120 nm to 200 nm.

The copolymer may comprise:

0.0001 to 4 wt % ethylenically unsaturated acid (or salts thereof) monomer based on the dry weight of the copolymer acid groups form acidic monomers, and
0 to 4 wt % of (meth)acrylamide monomer based on the dry weight of the copolymer.

The copolymer may comprise:

0 to 4 wt % or 0.0001 to 4 wt % ethylenically unsaturated acid (or salts thereof) monomer based on the dry weight of the copolymer acid groups form acidic monomers, and
0 to 3 wt %, or 0 to 2 wt % of (meth)acrylamide monomer based on the dry weight of the copolymer.

The copolymer may comprise:

0 to 4 wt % or 0.0001 to 4 wt % ethylenically unsaturated acid (or salts thereof) monomer based on the dry weight of the copolymer acid groups form acidic monomers, and
0 to 2 wt %, or 0 to 1 wt % of (meth)acrylamide monomer based on the dry weight of the copolymer.

The copolymer may comprise:

0 to 4 wt % or 0.0001 to 4 wt % ethylenically unsaturated acid (or salts thereof) monomer based on the dry weight of the copolymer acid groups form acidic monomers, and
0 to 0.1 wt % of (meth)acrylamide monomer based on the dry weight of the copolymer.

The copolymer may comprise:

0 to 4 wt % or 0.0001 to 4 wt % ethylenically unsaturated acid (or salts thereof) monomer based on the dry weight of the copolymer acid groups form acidic monomers, and
0 wt % of (meth)acrylamide monomer based on the dry weight of the copolymer.

Typically the copolymer contains 0.0001 to 4 wt %, or 0.0001 to 3 wt %, or 0.0001 to 2.5 wt %, or 0.0001 to 2 wt % ethylenically unsaturated acid (or salts thereof) monomer based on the dry weight of the copolymer acid groups form acidic monomers.

The copolymer may comprise:

0.0001 to 2 wt % ethylenically unsaturated acid (or salts thereof) monomer based on the dry weight of the copolymer acid groups form acidic monomers, and
0 wt % of (meth)acrylamide monomer based on the dry weight of the copolymer.

The copolymer may comprise:

1 to 4 wt %, or 1 to 2 wt % ethylenically unsaturated acid (or salts thereof) monomer based on the dry weight of the copolymer acid groups form acidic monomers, and
0 wt % of (meth)acrylamide monomer based on the dry weight of the copolymer.

The copolymer may comprise:

Acrylic copolymer comprises 1 to 4 wt %, or 1 to 2 wt % ethylenically unsaturated acid (or salts thereof) monomer based on the dry weight of the copolymer acid groups form acidic monomers, and
0 wt % of (meth)acrylamide monomer based on the dry weight of the copolymer and the Tg is 0 to 7.5° C.

The copolymer may comprise:

Acrylic copolymer comprises 1 to 4 wt %, or 1 to 2 wt % ethylenically unsaturated acid (or salts thereof) monomer based on the dry weight of the copolymer acid groups form acidic monomers, and
0 wt % of (meth)acrylamide monomer based on the dry weight of the copolymer,
and a particle size of 80 to 700 nm, 120 to 700 nm, or 80 to 200 nm, or 120 to 200 nm.

The copolymer may comprise:

Acrylic copolymer comprises 1 to 4 wt %, or 1 to 2 wt % ethylenically unsaturated acid (or salts thereof) monomer based on the dry weight of the copolymer acid groups form acidic monomers, and
0 wt % of (meth)acrylamide monomer based on the dry weight of the copolymer, the Tg is 0 to 7.5° C., and a particle size of 80 to 700 nm, 120 to 700 nm, or 80 to 200 nm, or 120 to 200 nm.

The copolymer may comprise:

0 wt % ethylenically unsaturated acid (or salts thereof) monomer based on the dry weight of the copolymer acid groups form acidic monomers, and
0 wt % of (meth)acrylamide monomer based on the dry weight of the copolymer.

In one embodiment the copolymer does not comprise a crosslinker monomer.

In one embodiment the copolymer comprises a crosslinker monomer. A copolymer containing crosslinker may be referred to as a crosslinker copolymer. Crosslinking is known to the skilled person in the art and reviewed in a paper published in JCT Research, vol 1, No 3, July 2004 entitled “Functional Latex and Thermoset Latex Films”, authors Taylor and Winnik. The paper reviews advances in design and development of functional latex particles that can be used to form crosslinked coatings. The process described in the paper, and in the articles cited are known in the art for preparing crosslinked polymers.

The copolymer may comprise:

0.0001 to 4 wt % ethylenically unsaturated acid (or salts thereof) monomer based on the dry weight of the copolymer acid groups form acidic monomers,
0 to 4 wt % of (meth)acrylamide monomer based on the dry weight of the copolymer, and
0 to 6 wt % (or 0 to 4 wt %, or 1 to 3.5 wt %) of a crosslinker monomer.

The copolymer may comprise:

0 to 4 wt % or 0.0001 to 4 wt % ethylenically unsaturated acid (or salts thereof) monomer based on the dry weight of the copolymer acid groups form acidic monomers,
0 to 3 wt %, or 0 to 2 wt % of (meth)acrylamide monomer based on the dry weight of the copolymer, and
0 to 6 wt % (or 0 to 4 wt %, or 1 to 3.5 wt %) of a crosslinker monomer.

The copolymer may comprise:

0 to 4 wt % or 0.0001 to 4 wt % ethylenically unsaturated acid (or salts thereof) monomer based on the dry weight of the copolymer acid groups form acidic monomers,
0 to 2 wt %, or 0 to 1 wt % of (meth)acrylamide monomer based on the dry weight of the copolymer, and
0 to 6 wt % (or 0 to 4 wt %, or 1 to 3.5 wt %) of a crosslinker monomer.

The copolymer may comprise:

0 to 4 wt % or 0.0001 to 4 wt % ethylenically unsaturated acid (or salts thereof) monomer based on the dry weight of the copolymer acid groups form acidic monomers,
0 to 0.1 wt % of (meth)acrylamide monomer based on the dry weight of the copolymer, and
0 to 6 wt % (or 0 to 4 wt %, or 1 to 3.5 wt %) of a crosslinker monomer.

The copolymer may comprise:

0 to 4 wt % or 0.0001 to 4 wt % ethylenically unsaturated acid (or salts thereof) monomer based on the dry weight of the copolymer acid groups form acidic monomers,
0 wt % of (meth)acrylamide monomer based on the dry weight of the copolymer, and
0 to 6 wt % (or 0 to 4 wt %, or 1 to 3.5 wt %) of a crosslinker monomer.
Typically the copolymer contains 0.0001 to 4 wt %, or 0.0001 to 3 wt %, or 0.0001 to 2.5 wt %, or 0.0001 to 2 wt % ethylenically unsaturated acid (or salts thereof) monomer based on the dry weight of the copolymer acid groups form acidic monomers, and 0 to 6 wt % (or 0 to 4 wt %, or 1 to 3.5 wt %) of a crosslinker monomer.

The copolymer may comprise:

0.0001 to 2 wt % ethylenically unsaturated acid (or salts thereof) monomer based on the dry weight of the copolymer acid groups form acidic monomers,
0 wt % of (meth)acrylamide monomer based on the dry weight of the copolymer, and
0 to 6 wt % (or 0 to 4 wt %, or 1 to 3.5 wt %) of a crosslinker monomer.

The copolymer may comprise:

1 to 4 wt %, or 1 to 2 wt % ethylenically unsaturated acid (or salts thereof) monomer based on the dry weight of the copolymer acid groups form acidic monomers,
0 wt % of (meth)acrylamide monomer based on the dry weight of the copolymer, and
0 to 6 wt % (or 0 to 4 wt %, or 1 to 3.5 wt %) of a crosslinker monomer.

The copolymer may comprise:

Acrylic copolymer comprises 1 to 4 wt %, or 1 to 2 wt % ethylenically unsaturated acid (or salts thereof) monomer based on the dry weight of the copolymer acid groups form acidic monomers,
0 wt % of (meth)acrylamide monomer based on the dry weight of the copolymer, and
0 to 6 wt % (or 0 to 4 wt %, or 1 to 3.5 wt %) of a crosslinker monomer, and the Tg is 0 to 18° C.

The copolymer may comprise:

Acrylic copolymer comprises 1 to 4 wt %, or 1 to 2 wt % ethylenically unsaturated acid (or salts thereof) monomer based on the dry weight of the copolymer acid groups form acidic monomers, and
0 wt % of (meth)acrylamide monomer based on the dry weight of the copolymer, and
0 to 6 wt % (or 0 to 4 wt %, or 1 to 3.5 wt %) of a crosslinker monomer.
and a particle size of 80 to 700 nm, 120 to 700 nm, or 80 to 200 nm, or 120 to 200 nm.

The copolymer may comprise:

Acrylic copolymer comprises 1 to 4 wt %, or 1 to 2 wt % ethylenically unsaturated acid (or salts thereof) monomer based on the dry weight of the copolymer acid groups form acidic monomers,
0 wt % of (meth)acrylamide monomer based on the dry weight of the copolymer, and
0 to 6 wt % (or 0 to 4 wt %, or 1 to 3.5 wt %) of a crosslinker monomer.
the Tg is 0 to 7.5° C., and a particle size of 80 to 700 nm, 120 to 700 nm, or 80 to 200 nm, or 120 to 200 nm.

The copolymer may comprise:

0 wt % ethylenically unsaturated acid (or salts thereof) monomer based on the dry weight of the copolymer acid groups form acidic monomers,
0 wt % of (meth)acrylamide monomer based on the dry weight of the copolymer, and
0 to 6 wt % (or 0 to 4 wt %, or 1 to 3.5 wt %) of a crosslinker monomer.

The copolymer may be prepared by a process known in the art to prepare an emulsion copolymer. The emulsion copolymer may be typically prepared by employing aqueous emulsion polymerization techniques known in the art.

The ethylenically unsaturated monomer may include (meth)acrylic ester monomers including methyl (meth)acrylate, ethyl (meth)acrylate, propyl (meth) acrylate, isopropyl (meth)acrylate, n-butyl (meth)acrylate, 2-ethylhexyl (meth)acrylate, isobutyl (meth)acrylate, sec-butyl (meth)acrylate, t-butyl (meth)acrylate, pentyl (meth)acrylate, isopentyl (meth)acrylate, hexyl (meth)acrylate, 2-ethylhexyl (meth)acrylate, octyl (meth)acrylate decyl (meth)acrylate isodecyl (meth)acrylate, lauryl (meth)acrylate, 3,5,5-trimethylhexyl (meth)acrylate, dodecyl (meth)acrylate, cetyl (meth)acrylate, cetylestearic (meth)acrylate, estearic (meth)acrylate, octadecyl (tttmeth)acrylate, cyclohexyl (meth)acrylate, hydroxyethyl methacrylate, hydroxypropyl methacrylate; (meth)acrylonitrile; (meth)acrylamide; amino-functional and ureido-functional monomers; silane functional monomers, including methacryloxy-propyltrimethoxy silane); monomers bearing acetoacetate-functional groups; styrene and substituted styrenes; butadiene; ethylene, propylene, α-olefins such as 1-decene; vinyl acetate, vinyl butyrate and other vinyl esters; and vinyl monomers such as vinyl chloride, vinylidene chloride. Typically are all-acrylic, predominantly acrylic, styrene/acrylic copolymers. As mentioned above, the (meth)acrylamide may or may not be present in a treat rate disclosed as an the ethylenically unsaturated monomer, typically not present from the monomer list above.

The ethylenically unsaturated monomers listed above may be used to prepare a copolymer.

The copolymer may comprise repeating units of:

units derived from (meth)acrylic acid ester;
units derived from one or more styrenic monomer; and
units derived from unsaturated nitrile monomer.

The acrylic acid esters and methacrylic acid esters may be represented by the following formula I:

CH₂═C(R₁)C(O)OR₂

wherein R₁ is hydrogen or a methyl group, and R₂ contains from 1 to 100 carbon atoms, or from 1 to 50, or from 1 to 25, or 1 to 10 (often 8) carbon atoms, and optionally, one or more sulphur, nitrogen, phosphorus, silicon, halogen and/or oxygen atoms. Examples may include (meth)acrylate esters, including methyl (meth)acrylate, ethyl (meth)acrylate, n-propyl (meth)acrylate, n-butyl (meth)acrylate, isopropyl (meth)acrylate, isobutyl (meth)acrylate, tert-butyl (meth)acrylate, n-amyl (meth)acrylate, n-hexyl (meth)acrylate, isoamyl (meth)acrylate, 2-hydroxyethyl (meth)acrylate, 2-hydroxypropyl (meth)acrylate, 4-hydroxybutyl (meth)acrylate, N,N-dimethylamino ethyl (meth)acrylate, N,N-diethylaminoethyl (meth)acrylate, t-butyl amino ethyl (meth)acrylate, 2-sulphoethyl (meth)acrylate, trifluoroethyl (meth)acrylate, glycidyl (meth)acrylate, benzyl (meth)acrylate, allyl (meth)acrylate, 2-n-butoxyethyl (meth)acrylate, 2-chloroethyl (meth)acrylate, sec-butyl-(meth)acrylate, tert-butyl (meth)acrylate, 2-ethylbutyl (meth)acrylate, cinnamyl (meth)acrylate, crotyl (meth)acrylate, cyclohexyl (meth)acrylate, cyclopentyl (meth)acrylate, 2-ethoxyethyl (meth)acrylate, furfuryl (meth)acrylate, hexafluoroisopropyl (meth)acrylate, methallyl (meth)acrylate, 3-methoxybutyl (meth)acrylate, 2-methoxybutyl (meth)acrylate, 2-nitro-2-methylpropyl (meth)acrylate, n-octyl (meth)acrylate, 2-ethylhexyl (meth)acrylate, 2-phenoxyethyl (meth)acrylate, 2-phenylethyl (meth)acrylate, phenyl (meth)acrylate, propargyl (meth)acrylate, tetrahydrofurfuryl (meth)acrylate, norbornyl (meth)acrylate, acrylamide and its derivatives, and tetrahydropyranyl (meth)acrylate. Mixtures of acrylic and methacrylic acid esters may be used. The polymer may comprise a copolymer containing repeating units derived from one or more of the foregoing acrylic acid esters and/or methacrylic acid esters. The acrylic and/or methacrylic acid esters may be used to provide from 0 to 100 wt % of the repeating units of the copolymer, or from 40 to 100 wt %, or 60 wt % to 90 wt %.

The unsaturated nitrile monomer that may comprise acrylonitrile or alkyl derivatives thereof. The alkyl group may have from 1 to 4 carbon atoms. These monomers may include acrylonitrile, methacrylonitrile, and the like. The monomers that may be used may include one or more unsaturated monomers containing one or more cyano groups such as those having the formula II:

CH₂═C(R)C(O)OCH₂CH₂CN (II)

wherein R is H or CₙH₂ₙ₊₁ and n is 1 to 4. Other examples of unsaturated nitrile monomers that may be used may include CH₂═C(CN)₂, CH₃—CH═CH—CN, NC—CH═CH—CN, 4-pentenenitrile, 3-methyl-4-pentenenitrile, 5-hexenenitrile, 4-vinyl-benzonitrile, 4-allyl-benzonitrile, 4-vinyl-cyclohexanecarbonitrile, 4-cyanocyclohexene, and the like. Mixtures of the unsaturated nitriles may also be used. Acrylonitrile and methacrylonitrile may be useful. The polymer may comprise a copolymer containing repeating units derived from one or more of the foregoing nitrile monomers. The unsaturated nitrile monomer may be used to provide from 0 to 25 wt % of the repeating units of the copolymer, or from 0 to 10 wt %, or 1 to 5 wt %.

The “styrenic monomers” that may be used to provide the repeating units of the polymer may comprise monomers containing a carbon-carbon double bond in alpha-position to an aromatic ring. The styrenic monomers may be represented by one or more of the following formulae:

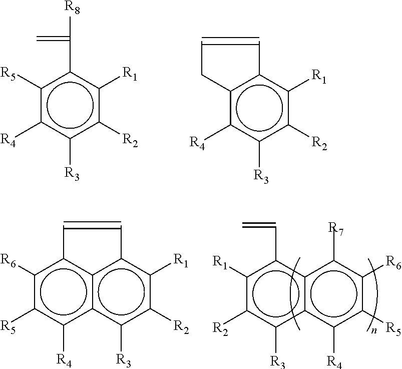

wherein n is an integer from 0 to 2; R₁, R₂, R₃, R₄, R₅, R₆, and R₇ may independently be H, CH₃, CₘH₂ₘ₊₁, OH, OCH₃, OCₘH₂ₘ₊₁ COOH, COOCH₃, COOCₘH₂ₘ₊₁, Cl or Br; m may be an integer from 2 to 9; and R₈ may be H, CH₃, CₘH₂ₘ₊₁, or C₆H₅.

Examples of the styrenic monomers that may be used may include styrene, alpha-methylstyrene, tertiary butylstyrene, ortho, meta, and para-methylstyrene, ortho-, meta- and para-ethylstyrene, o-methyl-p-isopropylstyrene, p-chlorostyrene, p-bromostyrene, o,p-dichlorostyrene, o,p-dibromostyrene, ortho-, meta- and para-methoxystyrene, indene and its derivatives, vinylnaphthalene, diverse vinyl (alkyl-naphthalenes) and vinyl (halonaphthalenes) and mixtures thereof, acenaphthylene, diphenylethylene, and vinyl anthracene. Mixtures of two or more styrenic monomers also may be used. The copolymer may comprise repeating units derived from one or more of the foregoing styrenic monomers (typically styrene). The styreneic monomer may be used to provide from 0 to 99 wt % of the repeating units of the copolymer, or from 0 to 90, or 5 to 35 wt %.

The ethylenically unsaturated acid groups may be derived from monomers chosen from acrylic acid, methacrylic acid, crotonic acid, vinylacetic acid and acryloxypropionic acid; C4-C8 monoethylenically unsaturated dicarboxylic acids and the alkali metal and ammonium salts thereof, and the anhydrides of the cis-dicarboxylic acids such as for example itaconic acid, fumaric acid, maleic acid, monomethyl itaconate, monomethyl fumarate, monobutyl fumarate, maleic anhydride; as well as many other examples of non-phosporous acid functional monomers, including ethacrylic acid, α-chloroacrylic acid, α-vinylacrylic acid, α-phenylacrylic acid, cinnamic acid, chlorocinnamic acid and β-styrylacrylic acid, 2-acrylamido-2-methylpropane sulphonic acid, vinyl sulphonic acid, styrene sulphonic acid, 1-allyloxy-2-hydroxypropane sulphonic acid, alkyl allyl sulphosuccinic acid, sulphoethyl (meth)acrylate, vinyl phosphonic acid, phosphoalkyl (meth)acrylates such as phosphoethyl (meth)acrylate, phosphopropyl (meth)acrylate, and phosphobutyl (meth)acrylate, phosphoalkyl crotonates, phosphoalkyl maleates, phosphoalkyl fumarates, phosphodialkyl (meth)acrylates, phosphodialkyl crotonates, and allyl phosphate.

The crosslinker monomer that may be used may include melamine and other formaldehyde-based crosslinking monomers, zinc and zirconium crosslinking monomers, aziridine crosslinking monomers, polycarbodiimide crosslinking monomers, oxirane crosslinking monomers, oxazoline crosslinking monomers, isopropenyl crosslinking monomers, unsaturation crosslinking monomers, polyfunctional (metha)acrylic/vinylic monomers, acetoacetoxy crosslinking monomers diaceton acrylamide crosslinking monomers, enamine and amine crosslinking monomers, or crosslinking using Diels-Alder reactions. Some examples of these crosslinkers include (meth)acrylamide, N-methylolacrylamide, N-butyl (meth)acrylamide, ethyleneurea or dimethylolethyleneurea, trimethylolpropane diallyl ether (TMPDE90) or divinylbenzene, or monomers as 1,4 butanediol diacrylate.

The fatty acid may be a C₈₋₂₀ or C₁₂₋₁₈, linear, branched, aromatic, aliphatic, synthetic and natural, fatty acid or salt thereof.

The fatty acid in one embodiment is aliphatic, and may be saturated or unsaturated.

The fatty acid may for instance be oleic acid, palmitic acid, coconut acid, olive oil fatty acid, linoleic acid, eicosic acid, or mixtures thereof.

The fatty acid may typically be in the form of a salt. The salt of the fatty acid may be an alkali metal, or alkaline earth metal, or an ammonium salt, or mixtures thereof.

The alkali metal may include sodium, lithium or potassium, typically potassium.

The alkaline earth metal may include calcium or magnesium.

The fatty acid salt may be a potassium oleate, potassium palmate, potassium cocoate, or potassium olivate (potassium salt of olive oil).

The acrylic copolymer disclosed herein may core/shell, or gradient, or hollow sphere, or multilobe morphology, or internal domain morphology architecture. In one embodiment the acrylic copolymer has core/shell architecture. In one embodiment the acrylic copolymer has gradient architecture. In one embodiment the acrylic copolymer is a homogeneous latex.

The homogeneous latex may be formed when the acrylic copolymer does not contain acidic groups.

When the acrylic copolymer comprises acidic groups the copolymer may be a homogenous latex with higher concentration of acid groups on the surface of latex particle.

The process to prepare the acrylic copolymer may include an aliphatic or aromatic surfactant. Examples of the surfactant include alkyl sulphates, alkylethersulphates (FAES), alkylphenol ether sulphates (APEOs), alkylbenzene sulphonic acids and their salts, alkyl sulphosuccinic acid and their salts, alkyl sulphosuccinamic acids and their salts, di-alkyl sulphosuccinic acid and their salts, alkyl ether phosphate acids and their salts, alkylphenol ether phosphate acids and their salts, fatty alcohol (C8-C18 or octyl, ethylhexyl, dodecyl, lauryl, cethyl, oleyl-cetyl) ethoxylates, alkylphenol ethoxylates, alkyl polyglycosides, dihydrosteraric acid, sodium or ammonium salts, polyethoxylenated fatty amines, polyethyleneglycols, amine based EO/PO co-polymers, fatty acids diethanolamides, alkanolamides and their ethoxylates ethylene oxide-propylene oxide block copolymers, sorbitan esters, sorbitan esters ethoxylated, ricine oil ethoxylated, poly ethylene and propylene glycols, sodium hexadecyl diphenyloxide disulphonate, sodium 2-(2-(2-tridecyloxy)etoxy)ethyl sulphate, C12,C14 alkylether sulphate, sodium alphaolefin sulphonate, phosphate ester of tridecyl alcohol ethoxylate, phosphate ester of tridecyl alcohol, phosphate coesters of alcohol and aliphatic ethoxylate, phosphated alcohol.

Examples of an aromatic surfactant present during polymerization include C₁₋₃₆, C₆₋₂₄ alkyl diphenyloxide disulphonate such as C₁₆ alkyl diphenyloxide disulphonate, or a salt of hexadecyl diphenyloxide disulphonate (typically sodium, potassium, lithium, calcium or an ammonium salt of C₁₋₃₆, C₆₋₂₄ alkyl diphenyloxide disulphonate (such as sodium hexadecyl diphenyloxide disulphonate).

The wetting agent may be an anionic and/or nonionic wetting agent. The wetting agent may include alkali metal or ammonium salts of alkyl, aryl, or alkylaryl sulphates, sulphonates or phosphates; alkyl sulphonic acids; sulphosuccinate salts; fatty acids; ethylenically unsaturated surfactant monomers; and ethoxylated alcohols or phenols.

Wetting agent is typically added in an amount of 0.001 to 20 wt %, or 0.005 to 10 wt %, or 0.01 to 5 wt % based on the total amount of monomers.

Examples of wetting agents include alkyl sulphates, alkylethersulphates (FAES), alkylphenol ether sulphates (APEOs), alkylbenzene sulphonic acids and their salts, alkyl sulphosuccinic acid and their salts, alkyl sulphosuccinamic acids and their salts, di-alkyl sulphosuccinic acid and their salts, alkyl ether phosphate acids and their salts, alkylphenol ether phosphate acids and their salts, fatty alcohol (C8-C18 or octyl, ethylhexyl, dodecyl, lauryl, cethyl, oleyl-cetyl) ethoxylates, alkylphenol ethoxylates, alkyl polyglycosides, dihydrosteraric acid, sodium or ammonium salts, polyethoxylenated fatty amines, polyethyleneglycols, amine based EO/PO co-polymers, fatty acids diethanolamides, alkanolamides and their ethoxylates ethylene oxide-propylene oxide block copolymers, sorbitan esters, sorbitan esters ethoxylated, ricine oil ethoxylated, poly ethylene and propylene glycols, sodium hexadecyl diphenyloxide disulphonate, sodium 2-(2-(2-tridecyloxy)etoxy)ethyl sulphate, C12,C14 alkylether sulphate, sodium alphaolefin sulphonate, phosphate ester of tridecyl alcohol ethoxylate, phosphate ester of tridecyl alcohol, phosphate coesters of alcohol and aliphatic ethoxylate, phosphated alcohol.

The alkali removable agent may include a polymeric material having free acidic groups such as poly(meth)acrylic acid, or copolymers thereof.

Examples of the alkali removable agent include Carboset 514H (acrylic latex from Lubrizol), Carboset 511 (acrylic latex from Lubrizol), Carboset 515 (acrylic latex from Lubrizol), and Carboset 525 (acrylic latex from Lubrizol).

In another aspect of the present invention, emulsion polymer may be prepared by a multi-stage or single-stage process and the process may be batch (shot), semi-batch (gradual addition, semi-continuous), or continuous.

The following examples provide illustrations of the disclosed technology. These examples are non-exhaustive and are not intended to limit the scope of the disclosed technology.

### Example 1

### Preparation of Aqueous Copolymer Compositions

This example shows the general procedure used to prepare acrylic copolymers of the present invention. A specific formulation is used as illustration purposes, but it is understood that one skilled in the art may vary the ingredients to obtain variations of the formulas, some of which are shown in example 2 below. Such compositions are incorporated into the formulations described in the example 1 and evaluated according to further examples.

### Preparation for 0 phm Acid, PS=85 nm and Linear Tg=11° C.

A monomer emulsion is prepared using 178 g of Demineralized (DM) water, 1.626 g ammonium carbonate, 9.29 g of 35% weight active C16 alkyl diphenyloxide disulphonate (SUR1) ingredient, 81.3 g methylmethacrylate (MMA), 777 g 2-ethylhexylacrylate (2EHA), 527 g styrene (STY) and 97.6 g acrylonitrile (VCN). A five liters, 4-neck round bottom flask containing an initial charge of 1187 g DM water 1.626 g ammonium carbonate, 57.6 g of 35% weight active C16 alkyl diphenyloxide disulphonate (SUR1) ingredient is heated to 80° C., using or not nitrogen atmosphere. When kick-off temperature is reached, 4.066 g of ammonium persulphate (APS) dissolved in 16 g DM water is added to the flask. After two minutes stirring, the monomer emulsion is fed during 30 minutes and then stopped for 15 minutes. After 15 minutes, monomer emulsion feed a solution of 3,253 g of APS in 163 g of DM water are added to the reaction flask over 150 and 210 minutes, respectively. Reaction Temperature is maintained at 80° C. during the addition. 45 g STY and 45 g 2-EHA are added to the reactor at the end of monomer emulsion feed. When all the additions are completed, containers are rinsed with 49 g of DM water which are added to the reaction flask. A redox pair is added 30 minutes after catalyst metering is completed to reduce free monomers content. The polymer is neutralized with aqueous ammonia (25%).

### Preparation for 1.5 phm Acid, PS=160 nm and Linear Tg=7.5° C.

A monomer emulsion is prepared using 630 g of Demineralized (DM) water, 1.8 g ammonium carbonate, 12.00 g of 30% weight active C13 alkyl ether sulphate ethoxylate (SUR2) ingredient, 3.4 g methacrylic acid (MAA), 3.4 g acrylic acid (AA), 90.0 g methylmethacrylate (MMA), 904 g 2-ethylhexylacrylate (2EHA), 514 g styrene (STY) and 108.0 g acrylonitrile (VCN). A five liters, 4-neck round bottom flask containing an initial charge of 1314 g DM water 1.8 g ammonium carbonate, 3.0 g of 30% weight active C13 alkyl ether sulphate ethoxylate (SUR2) ingredient is heated to 80° C., using or not nitrogen atmosphere. When kick-off temperature is reached, 4.5 g of ammonium persulphate (APS) dissolved in 18 g DM water is added to the flask. After two minutes stirring, the monomer emulsion is fed during 30 minutes and then stopped for 15 minutes in order to add the reminder of (meth) acrylic acids monomers (9.6 g MAA and 9.6 g AA) to the monomer emulsion. After 15 minutes, monomer emulsion and a solution of 3.600 g of APS in 180 g of DM water are added to the reaction flask over 150 and 210 minutes, respectively. Reaction Temperature is maintained at 80° C. during the addition. 45 g STY and 45 g 2-EHA are added to the reactor at the end of monomer emulsion feed. When all the additions are completed, containers are rinsed with 54 g of DM water, which are added to the reaction flask. A redox pair is added 30 minutes after initiator metering is completed to reduce free monomers content. The polymer is neutralized with aqueous ammonia (25%).

### Preparation for 1.5 phm Acid, PS=80 nm and Linear Tg=7.5° C.

A monomer emulsion is prepared using 630 g of Demineralized (DM) water, 1.800 g ammonium carbonate, 12.00 g of 30% weight active C12,C14 alkyl ether sulphate ethoxylate (SUR3) ingredient, 3.4 g methacrylic acid (MAA), 3.4 g acrylic acid (AA), 90.0 g methylmethacrylate (MMA), 904 g 2-ethylhexylacrylate (2EHA), 514 g styrene (STY) and 108.0 g acrylonitrile (VCN). A five liters, 4-neck round bottom flask containing an initial charge of 1314 g DM water 1.800 g ammonium carbonate, 60.0 g of 30% weight active C12,C14 alkyl ether sulphate ethoxylate (SUR3) ingredient is heated to 80° C., using or not nitrogen atmosphere. When kick-off temperature is reached, 4.5 g of ammonium persulphate (APS) dissolved in 18 g DM water is added to the flask. After two minutes stirring, the monomer emulsion is fed during 30 minutes and then stopped for 15 minutes in order to add the reminder of (meth) acrylic acids monomers (9.6 g MAA and 9.6 g AA) to the monomer emulsion. After 15 minutes, monomer emulsion and a solution of 3.600 g of APS in 180 g of DM water are added to the reaction flask over 150 and 210 minutes, respectively. Reaction Temperature is maintained at 80° C. during the addition. 45 g STY and 45 g 2-EHA are added to the reactor at the end of monomer emulsion feed. When all the additions are completed, containers are rinsed with 54 g of DM water which are added to the reaction flask. A redox pair is added 30 minutes after catalyst metering is completed to reduce free monomers content. The polymer is neutralized with aqueous ammonia (25%).

### Preparation for 1.5 phm Acid, 2.87 Phm Crosslinker, PS=95 nm and Linear Tg=17.4° C.

A monomer emulsion is prepared using 239 g of Demineralized (DM) water, 1.817 g ammonium carbonate, 52.4 g of diacetone acrylamide, 10.38 g of 35% weight active C16 alkyl diphenyloxide disulphonate (SUR1) ingredient, 3.5 g methacrylic acid (MAA), 3.5 g acrylic acid (AA), 90.8 g methylmethacrylate (MMA), 868 g 2-ethylhexylacrylate (2EHA), 589 g styrene (STY) and 109 g acrylonitrile (VCN). A five liters, 4-neck round bottom flask containing an initial charge of 1204 g DM water 1.817 g ammonium carbonate, 64.4 g of 35% weight active C16 alkyl diphenyloxide disulphonate (SUR1) ingredient is heated to 80° C., using or not nitrogen atmosphere. When kick-off temperature is reached, 4.541 g of ammonium persulphate (APS) dissolved in 18 g DM water is added to the flask. After two minutes stirring, the monomer emulsion is fed during 30 minutes and then stopped for 15 minutes in order to add the reminder of (meth) acrylic acids monomers (9.6 g MAA and 9.6 g AA) to the monomer emulsion. After 15 minutes, monomer emulsion feed a solution of 3,633 g of APS in 182 g of DM water are added to the reaction flask over 150 and 210 minutes, respectively. Reaction Temperature is maintained at 80° C. during the addition. 45 g STY and 45 g 2-EHA are added to the reactor at the end of monomer emulsion feed. When all the additions are completed, containers are rinsed with 54 g of DM water which are added to the reaction flask. A redox pair is added 30 minutes after catalyst metering is completed to reduce free monomers content. The polymer is neutralized with aqueous ammonia (25%) before adding 18.3 g of adipic acid dihidrazide dissolved in 122 g of DM water.

A variety of compositions and characterizations of such are shown in the following example.

### Example 2

### Formulation of Aqueous Copolymer Compositions

This example shows specific copolymer compositions that are prepared according to the procedure described in the example 1. Such compositions are incorporated into the formulations described in the Example 3 below and then evaluated as described in further examples. Table 2.1 below show copolymer compositions tested in the present invention.

TABLE 2.1

| Polymer | | | | | | | | | | | X- |
|---|---|---|---|---|---|---|---|---|---|---|---|
| sample | MAA | AA | MMA | A2EH | ST | VCN | MAA | AA | 2EHA | ST | linker |
| 1 | 0.07 | 0.07 | 5.20 | 43.10 | 39.77 | 6.24 | 0.18 | 0.18 | 2.60 | 2.60 | 0 |
| 2 | 0.07 | 0.07 | 5.20 | 43.10 | 39.77 | 6.24 | 0.18 | 0.18 | 2.60 | 2.60 | 0 |
| 3 | 0.20 | 0.20 | 5.20 | 43.40 | 38.47 | 6.24 | 0.55 | 0.55 | 2.60 | 2.60 | 0 |
| 4 | 0.20 | 0.20 | 5.20 | 52.20 | 29.67 | 6.24 | 0.55 | 0.55 | 2.60 | 2.60 | 0 |
| 5 | 0.07 | 0.07 | 5.20 | 51.95 | 30.92 | 6.24 | 0.18 | 0.18 | 2.60 | 2.60 | 0 |
| 6 | 0.20 | 0.20 | 5.20 | 43.40 | 38.47 | 6.24 | 0.55 | 0.55 | 2.60 | 2.60 | 0 |
| 7 | 0.07 | 0.07 | 5.20 | 51.95 | 30.92 | 6.24 | 0.18 | 0.18 | 2.60 | 2.60 | 0 |
| 8 | 0.20 | 0.20 | 5.20 | 52.20 | 29.67 | 6.24 | 0.55 | 0.55 | 2.60 | 2.60 | 0 |
| 9 | 0.13 | 0.13 | 5.20 | 47.70 | 34.67 | 6.24 | 0.37 | 0.37 | 2.60 | 2.60 | 0 |
| 10 | 0.13 | 0.13 | 5.20 | 47.70 | 34.67 | 6.24 | 0.37 | 0.37 | 2.60 | 2.60 | 0 |
| 11 | 0.13 | 0.13 | 5.20 | 47.70 | 34.67 | 6.24 | 0.37 | 0.37 | 2.60 | 2.60 | 0 |
| 12 | 0.00 | 0.00 | 5.20 | 47.43 | 35.94 | 6.24 | 0.00 | 0.00 | 2.60 | 2.60 | 0 |
| 13 | 0.26 | 0.26 | 5.20 | 47.95 | 33.42 | 6.24 | 0.74 | 0.74 | 2.60 | 2.60 | 0 |
| 14 | 0.13 | 0.13 | 5.20 | 56.55 | 25.82 | 6.24 | 0.37 | 0.37 | 2.60 | 2.60 | 0 |
| 15 | 0.13 | 0.13 | 5.20 | 38.70 | 43.67 | 6.24 | 0.37 | 0.37 | 2.60 | 2.60 | 0 |
| 16 | 0.00 | 0.00 | 5.20 | 49.69 | 33.68 | 6.24 | 0.00 | 0.00 | 2.60 | 2.60 | 0 |
| 17 | 0.20 | 0.20 | 4.97 | 47.55 | 32.23 | 5.97 | 0.53 | 0.53 | 2.49 | 2.49 | 2.87 |

Other copolymer compositions are prepared varying surfactant used maintaining PS, acid content and ratio ST/2EHA according to the table 2.2 below.

TABLE 2.2

| Polymer | | | | | | linear | X- |
|---|---|---|---|---|---|---|---|
| sample | SUR1 | SUR2 | SUR3 | PS | acid | Tg | linker |
| 1 | 1.04 | 1.04 | 1.04 | 80 | 0.5 | 22.5 | 0 |
| 2 | 0.01 | 0.052 | 0.026 | 160 | 0.5 | 22.5 | 0 |
| 3 | 1.04 | 1.04 | 1.04 | 80 | 1.5 | 22.5 | 0 |
| 4 | 0.01 | 0.052 | 0.026 | 160 | 1.5 | 7.5 | 0 |
| 5 | 0.01 | 0.052 | 0.026 | 160 | 0.5 | 7.5 | 0 |
| 6 | 0.01 | 0.052 | 0.026 | 160 | 1.5 | 22.5 | 0 |
| 7 | 1.04 | 1.04 | 1.04 | 80 | 0.5 | 7.5 | 0 |
| 8 | 1.04 | 1.04 | 1.04 | 80 | 1.5 | 7.5 | 0 |
| 9 | 0.052 | — | — | 120 | 1 | 15.0 | 0 |
| 10 | 4 | — | — | 40 | 1 | 15.0 | 0 |
| 11 | 0.005 | — | — | 200 | 1 | 15.0 | 0 |
| 12 | 0.068 | — | — | 120 | 0 | 15.0 | 0 |
| 13 | 0.042 | — | — | 120 | 2 | 15.0 | 0 |
| 14 | 0.052 | — | — | 120 | 1 | −0.1 | 0 |
| 15 | 0.052 | — | — | 120 | 1 | 30.3 | 0 |
| 16 | 1.29 | — | — | 80 | 0 | 11.1 | 0 |
| 17 | 1.23 | — | — | 95 | 1.5 | 17.4 | 2.87 |

### Example 3

### Preparation of Aqueous Coatings Compositions

This example shows how to prepare the aqueous coating formulation used to evaluate properties. Acrylic copolymers of the present invention are incorporated in aqueous coating compositions for evaluation according to standard techniques known by one skilled in the art and according formulations described below. Ingredients are added according to the formulation described in the table 3.1 and stirred until complete homogeneity. After mixing, all formulated polymers are filtered thru 150 microns and then thru 42 microns.

| Material | Grams | % | % on solids |
|---|---|---|---|
| Polymer base | 2741 | 75.0 | |
| Dextrol OC40 | 190 | 5.20 | 12.5 |
| DM water | 458 | 12.5 | |
| Ammonia 25% | 50 | 1.37 | |
| Potassium Oleate | 61 | 1.67 | 4.0 |
| DM water | 104 | 2.84 | |
| DM water | 27 | 0.738 | |
| Biocide | 5.55 | 0.152 | 0.366 |
| Dowanol DPM | 14.06 | 0.384 | 0.926 |
| LZ 2120 | 6.242 | 0.171 | 0.411 |
| TOTAL | 3657 | 100.0 | |

Polymer base = acrylic copolymer described in examples 1 and 2
Dextrol OC40 = example of wetting agent (is a trade Mark of Dexter)
Potassium Oleate = example of releasing agent
Dowanol DPM = coalescent (is a trademark of Dow)
LZ2120 = flash rush inhibitor and long term corrosion inhibitor(is a trademark of Lubrizol)

Clearcoat Properties:

| | |
|---|---|
| Total solids Mw (%) | 41.5 |
| pH | 8-9.2 |
| Br. Viscosity (cps) | <500 |
| Particle size (nm) | 30-1000 |

### Example 4

### Corrosion Resistance

This example examines the corrosion resistance properties of previous examples. Corrosion resistance is tested by exposure during a week (168 h) to a 5% sodium chloride solution using an inverted beaker system. Panels are prepared by drawing down the formulated polymers on2×100×305 mm GMC cut only; unpolished or 04×06×071 cut only or unpolished from ACT Test Panels LLC. Final dried film thickness is 3-4 mils (75-100 microns). Rust rating is evaluated after 1 week removing beaker and results are comparative. The results are rated in 0-5 scale, in which 0 is the worst and 5 is the best.

TABLE 4.1

| Polymer | | | |
|---|---|---|---|
| sample | SUR1 | SUR2 | SUR3 |
| 1 | 0 | 0 | 0 |
| 2 | 1 | 1 | 0 |
| 3 | 1 | 0 | 1 |
| 4 | 5 | 5 | 5 |
| 5 | 3 | 3 | 3 |
| 6 | 2 | 3 | 0 |
| 7 | 3 | 2 | 3 |
| 8 | 5 | 5 | 5 |
| 9 | 5 | — | — |
| 10 | 2 | — | — |
| 11 | 4 | — | — |
| 12 | 0 | — | — |
| 13 | 5 | — | — |
| 14 | 4 | — | — |
| 15 | 2 | — | — |
| 16 | 2 | — | — |
| 17 | 4 | — | — |

### Example 4

### Removability

This example examines the removability or peelability of the samples in previous examples. Peelability is tested in panels after 1 night drying at 50° C. and after 2 weeks at 50° C. Formulations are applied to HRS and CRS panels at a dry film thickness of 3-4 mils (75-100 microns). Panels are also 2×100×305 mm GMC cut only; unpolished or 04×06×071 cut only or unpolished from ACT Test Panels LLC. All the formulations revealed good removability even after 2 weeks at 50° C.

It is known that some of the materials described above may interact in the final formulation, so that the components of the final formulation may be different from those that are initially added. The products formed thereby, including the products formed upon employing lubricant composition of the present invention in its intended use, may not be susceptible of easy description. Nevertheless, all such modifications and reaction products are included within the scope of the present invention; the present invention encompasses lubricant composition prepared by admixing the components described above.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about”. Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention may be used together with ranges or amounts for any of the other elements.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. An emulsion acrylic copolymer in the form of a latex comprising an acrylic copolymer having 0 to 4 wt % repeating units from ethylenically unsaturated acid (or salts thereof) monomer based on the dry weight of the copolymer acid groups form acidic monomers, 0 to 4 wt % repeating units from (meth)acrylamide monomer based on the dry weight of the copolymer, a linear Tg of up to 30° C., and an average particle size of 30 to 1000 nm and wherein said emulsion acrylic copolymer further comprises 0.1 to 20 wt % of a C₄₋₃₀ fatty acid or salt thereof (peelability enhancing agent) based upon the solid content of said emulsion acrylic copolymer.

2. (canceled)

3. (canceled)

4. (canceled)

5. (canceled)

6. The acrylic copolymer of claim 1, wherein the acrylic copolymer has a Tg of −5 to 30° C.

7. (canceled)

8. (canceled)

9. (canceled)

10. (canceled)

11. (canceled)

12. The acrylic copolymer of claim 1, wherein the copolymer comprises:
0.0001 to 2.5 wt % repeating units from ethylenically unsaturated acid (or salts thereof) monomer based on the dry weight of the copolymer.

13. (canceled)

14. (canceled)

15. The acrylic copolymer of claim 1, wherein the copolymer comprise repeating units:
derived from (meth)acrylic acid ester;
derived from one or more styrenic monomer; and
derived from unsaturated nitrile monomer.

16. The acrylic copolymer of claim 1, wherein the fatty acid is a C₈₋₂₀ linear, branched, aromatic, aliphatic, synthetic and natural, fatty acid.

17. (canceled)

18. The acrylic copolymer of claim 16, wherein the fatty acid is a fatty acid salt.

19. The acrylic copolymer of claim 18, wherein the salt is an alkali metal, or alkaline earth metal, or an ammonium salt, or mixtures thereof.

20. The acrylic copolymer of claim 19, wherein the alkali metal may is sodium, lithium or potassium.

21. (canceled)

22. The acrylic copolymer of claim 20, wherein the fatty acid salt is a potassium oleate, potassium palmate, potassium cocoate, or potassium olivate.

23. (canceled)

24. (canceled)

25. (canceled)

26. (canceled)

27. (canceled)

28. (canceled)

29. (canceled)

30. (canceled)

31. (canceled)

32. (canceled)

33. The acrylic copolymer of claim 1, wherein the copolymer further comprises 1 to 3.5 wt % of a crosslinker monomer.

34. The acrylic copolymer of claim 33, wherein the copolymer has a Tg of −30 to 30° C. and a particle size of the acrylic copolymer containing crosslinker monomer of 80 to 200 nm.

35. A removable composition comprising 0.01 to 50 wt % of alkali removable agent, and 50 to 99.99 wt % of the acrylic copolymer of claim 1.

36. A method of protecting a surface comprising supplying to a surface a coating composition comprising the acrylic copolymer of claim 1, wherein the coating composition forms a film.

37. The method of claim 36, wherein the coating composition forms a temporary film on the surface.

38. (canceled)

39. The method of claim 36, wherein the surface may be a metal surface that is painted or unpainted.

40. (canceled)

41. (canceled)

42. (canceled)
